(19) United States
(12) Patent Application Publication
(10) Pub. No.: US 2014/0024422 A1
(43) Pub. Date: Jan. 23, 2014

(54) THRESHER HEAD WITH BUILT-IN PNEUMATIC SUCTION TO BE USED BY A HARVESTER

(71) Applicant: INTA Instituto Nacional de Technologia Agropecuaria, Buenos Aires (AR)

(72) Inventor: Oscar Ruben Pozzolo, Castelar (AR)

(73) Assignee: INTA Instituto Nacional de Technologia Agropecuaria

(21) Appl. No.: 13/940,718

(22) Filed: Jul. 12, 2013

(30) Foreign Application Priority Data
Jul. 20, 2012 (AR) 20120102629

(51) Int. Cl. A01F 12/18

(52) U.S. Cl. CPC A01F 12/18
USPC 460/65

(57) ABSTRACT

A thresher head of a harvester has a rotor rotating in the opposite direction to the progress of the machine and holding thresher teeth alignments through which grains are pulled. The rotor is a hollow cylindrical body associated with a command arrangement producing an independent rotary movement in the same direction as the rotor rotation. An axial concentric take air from the ends to generate a flow towards the rotor wall, the fan being associated with the command arrangement A flow channel between the rotor and the axial fan has a face covering more than half of the cylindrical curvature of the rotor, leaving a lower opening that receives the air flow. The hollow rotor holding the thresher teeth rotates at a lesser speed in the same direction as the axial fan.

### CROSS-REFERENCE TO RELATED APPLICATION

The present application claims the priority under 35 U.S.C. 119 of Argentine Application No. 20120102629, filed Jul. 20, 2012 in, which is hereby incorporated herein by reference in its entirety.

### FIELD OF THE INVENTION

The present invention, whereby an invention patent is being applied, relates to, as the main object thereof, a THRESHER HEAD WITH BUILT-IN PNEUMATIC SUCTION TO BE USED BY A HARVESTER, which differs from others in that the use of a relevant additional air current is incorporated, said current being produced by an internal fan, which main function is to generate a depression at the zone where the grains being harvested are discharged, and thereby producing a suction that prevents grains from falling into the soil, avoiding a factor of undesirable losses.

More specifically, the present invention covers a new harvester head, that pertains to the type of those usually called “Stripper” Heads that use the principle of operation called “by pulling”, said head comprising a front rotor, that rotates in the opposite direction to the progress of the machine, holding thresher teeth alignments, through which fruits (grains) are being pulled which, in turn, by centrifugal force, are thrown out towards the harvester; particularly, as per the present invention, besides the action of this front rotor, the action of an air current produced by an internal fan is added to, said fan is specially assembled to generate, in keeping with the discharge of grains being detached, a special depression that causes ascending suction towards the communication path with the harvester, preventing grains from wrongfully falling into the soil, and therefore increasing the working capacity and efficiency of the head.

Indeed, so as to put into practice the above mentioned principle of operation, the thresher head of this invention, different from the conventional ones, present a rotor that holds teeth, having a cylindrical sieving wall, with a coaxial fan which takes air from the ends, as both the rotor and the fan geometrically share the same axis cross to the direction of progress.

Furthermore, between the coaxial fan and the mentioned cylindrical rotor, holding the thresher teeth, a new air deflector is positioned specially designed so as the current being generated by said fan is directed towards the rear section of the head where the detachment occurs.

This air current causes the grains being pulled from the plants to be addressed towards the rear part of the thresher head, from where, through a worm, is carried to the harvester, in the same way as any head of fine harvest does.

This new air current, being generated according to the present invention, has as main object causing a depression at the anterior zone of the same head, at the section where the grains detachment occurs, guaranteeing that those that do not follow the path to the worm, falling down into the soil, may be absorbed and dragged towards said discharge outlet, together with the others.

This invention relates to a new combination of means designed to get a superior result, being this invention unforeseeable and surprising even for those skilled in the art. Accordingly, it can be seen that this is a clear inventive activity, so that, it meets the conditions being required by law to be considered an invention patent.

### PRIOR ART

As it is known, the “Stripper” heads are English embodiments that have been distributed along the main agricultural countries, starting the first local experiences thereof in rice cultivation zones, and then being increasingly introduced to the harvest of oats, fodders, flax, barley, and high performance wheat.

These known heads are made from a cylindrical rotor, holding thresher teeth alignments, with special features as they have notches similar to a “keyhole eye”, defining combs that extend cross to the progress direction of the harvester.

This rotor, and the structural rack thereof, are cantilevered located, cross over the front face of the harvester, keeping internal power requirements. During the operation it is rotated in the opposite direction to the progress of the machine, having embodiments that use six or eight combs.

Said operative rotations may be carried out with a variable speed, so that by being put into contact with the stems, material is guided by carrying the ears towards the above mentioned eye that constitute the teeth, which as being of a less size, causes the material to be “pulled”, elevated and thrown out towards a rear section where a worm acts associated to a carrier that moves the material towards the harvester.

The fact that this head does not cut the plant, guarantees that only grains and a low percentage of ears parts go into the harvester, meaning a great operative advantage as regards the conventional platforms of blade cutting.

Furthermore, the remaining of harvest keeps a vertical position that makes easy the harvester movement and the entrance of the herbicides into the lower strata of the crop residue. This principle of operation guarantees that a minimum amount of crop residue enters the harvester, being kept in the soil by its own roots, thus not being possible to be dragged by an eventual rain.

As regards the “stripper” threshers heads in general, the following advantages with relation to the purpose of use may be summed up:
Only grains and a low percentage of ears parts go into the harvester, therefore the progress speed is increased by 30% and 60%.
Fuel consumption is reduced up to 40%.
By selecting and reducing the amount of material that goes into the harvester, the wear and tear is distinctively diminished too.
The head may operate when the grain is ripe though leaves and stems are still green.
Most part of the cereal threshing is carried out by the head before entering the harvester, which is reflected by a better final cleaning.
At normal weather conditions, daily 24 hours harvests are allowed.

However, in spite of the preceding summarized advantages, it may be stated that losses produced by these thresher heads are higher than those generated by the conventional systems, that's why they have not been generally used yet.

In this sense, it was highly verified that this low operative performance is due to the fact that the impulse that the teeth transfer to the grains, in some instances, is not sufficient to establish a path that guarantees that all of them are going into the harvester. Collisions of grains one into another and against the walls of the head body may be produced causing their fall into the soil, thus not being possible to be recovered.

For the foregoing, this harvest system has not been so much spread worldwide, though innumerable advantages may be provided over the traditional systems; lower power requirements, possibility of manufacturing a more economical harvester, high working capacity, no pierced crop residue, etc.

It may be said that the main problem that these known thresher heads present, consists in that it is very difficult to control a little loss of grains. Losses depend on the relations among the rotation of the rotor, the speed of progress and the culture density, variables that permanently change. When an ideal relation is not used grains fall because they do not get to enter via the centrifugal force towards the harvester.

Furthermore, it is appreciated that the rotor, when rotating, would also operate as an axial fan that generates an air current, however, due to the configuration and design thereof, as it is of a closed structure without gaps among the vanes, with closed ends, no air current may be generated. This aerodynamic effect is limited to move the air in the peripheral environment, which, though it causes an adherence phenomenon towards the teeth, generates turbulences in the remaining space between teeth and the hood, which contributes to increase the losses of threshed grains.

Through years, various improvements applied to these thresher heads have been incorporated, trying to specifically optimize the operation thereof, most of which were the subject of the respective invention patents, among which the following are pointed out:

U.S. Pat. No. 4,951,451—titled UN Aparato para la Cosecha de Cultivos

This disclosure proposes a rotor where the teeth alignments as combs are combined with cross nerves and protuberant skirts with different inclinations. Furthermore, it teaches a configuration where the seeds and the materials separated by the action of the rotor are conducted below a guide cover.

U.S. Pat. No. 5,389,038—titled UN tambor separador de Cultivo:

This disclosure shows a rotor holding flexible axial teeth circumferentially spaced. In this case, it teaches special flexible teeth that produce pulling openings capable of adjustably adapting to different sizes of cultures.

U.S. Pat. No. 5,419,107—titled Aparato para extracción de cultivos:

In this case a rotor that pulls out the seeds combined with a collecting tray upon which a rotating roller works that rotates in the same sense as the rotor extractor, is disclosed.

U.S. Pat. No. 5,438,818—titled Separador de Cultivo:

In this case, a rotor holding various rows of thresher teeth is disclosed, these teeth present special inclinations having the purpose of reducing the movement of the stems to be trapped over the rotor body.

U.S. Pat. No. 6,315,659—titled Separador de Cultivo:

In this case, a rotor provided with improved metal teeth is disclosed, these are cone-shaped and slightly curved and are distributed according to two conformations of cooperating action, defining shorter and thick accompanying teeth, combined with pulling teeth, arranged in another orientation.

Argentine Patent Application P 19970100526—titled Cabezal Trillador y Colector de Granos aplicable a una maquina cosechadora.

It refers to a cantilevered head arranged cross to the direction of progress, comprising a structure that uses a mobile hood that encloses a rotor holding thresher teeth, associated to a rear worm that delivers the grains to the harvester, causing the detachment of grains without moving away the plants from the soil.

This disclosure teaches the use of special lateral plates constituting the head structure while holding the axis of the rotor and the worm, combined with a special transference tube that directs the grains towards a central section of communication with the harvester. None of the mentioned background teaches or at least suggests how to use a forced air current capable of generating a pneumatic depression at the zone of the outlet of the separated grains, when these are pulled towards the worm carrier located at the back.

Even less they disclose embodiments where said forced air current is generated by a fan coaxially assembled to the rotor axis.

### DESCRIPTION OF THE INVENTION—ADVANTAGES

The thresher head, referred to in the present invention, clearly solves the mentioned inconvenient by incorporating a new resource that generates a suction air current, through which losses of grains that were withdrawn and not transferred thus falling into the soil, practically disappear.

The invented head also has a cross rotor holding alignments of saw-shaped thresher teeth, preferably manufactured of a flexible polymer, made in such a way that when entering into the mass of a cereal culture, it first causes the pulling of the grains that then, by centrifugal force, are carried towards the harvester.

Furthermore, the head of this invention is distinguished as it presents a substantial improvement compared to the already known heads, because an air current produced by an internal fan is incorporated, which is duly oriented so that, at the head section, where the grains withdrawn by the rotor are discharged, an additional pneumatic depression is generated, which purpose is to guarantee that all the grains being withdrawn are sucked out in the direction of progress towards the harvester, preventing the undesirable fall into the soil.

When referring to the production of an air current, additional to the one that may be generated by the rotation of the rotor, it does not alter the relation of the rotation speed of the rotor as compared to the relation of the progress speed of the machine, as they behave in an independent manner.

Undoubtedly it refers to a very meaningful technological advance, as a series of problems due to production losses is solved by a extremely simple constructive solution of a very low cost (compared to the value of a harvester), highly efficient, and also compatible with any harvester in the market.

To put into practice the functional advantages stated in the preceding paragraphs, the invented thresher head is comprised of three main basic elements as follow:

Head Rotor

Comprises the mentioned cross cylindrical body; holding the alignments of thresher teeth oriented with a certain inclination depending on the use thereof. Preferably, by the time of being applied to a harvester, said teeth may present an inclination angle near 30°.

This element will be responsible for taking the grain, pulling from the plant and throwing out towards the worm carrier that is feeding the harvester. For the correct treatment of the grains being detached, this rotor usually rotates at relatively low revolutions, about 200 rpm during the progress of the harvester.

As it is known, this rotor is assembled in a cantilevered rack being projected from the front of the harvester, over which a holder axis associated to the command means is extended producing the mentioned rotations in the opposite sense to the direction of progress. Said commands may be chains and pulleys, or of a cycloidal type.

The invented rotor is also distinguished in that the cylindrical wall is affected by a multiplicity of minor openings through which the air current generated by a fan coaxially arranged within, may move along.

Axial Fan

Is a new internal axial fan, arranged concentric to the above mentioned rotor, extended in its interior space, which takes air from the ends, rotating at about 3000 rmp, as any axial fan does, being this air moved through the vanes thereof.

Its operation is independent from the rotor so it is associated to a proper command capable of generating the above mentioned revolutions. The invention is thereby considering the use of a transmission facility comprised of chains and pulleys, like the one that uses a moving gullet variator, or of the cycloidal type, in which case both take the propulsion from the harvester where the head is working.

Flow Channel

The third element is a channel of the air flow generated from the axial fan, through which the air is conducted towards the internal section where the grains that are withdrawn and then thrown out by the rotor towards the rear section of the head where the worm carrier is located, go out.

This flow channel guarantees that the air current generated by the axial fan is specifically directed towards the discharge outlet of the grains, removing the above mentioned losses due to spillage.

As it was previously indicated, said air current is generated at a speed much higher than the one generated by the rotor, causing loss of loading just in the lower part where the grains fall occurs. In this way, a depression is generated that significantly reduces the possibility of losses of grains during the harvest.

It is specially indicated that in order to get an air current capable of generating suction dragging the grains towards the outlet, the speed of the rotation of the rotor and that of the coaxial fans should be different. When the sieving rotor, holding the thresher teeth may rotate 400 and 800 s/min, the internal fan will do so at about 1,800 s/min.

In this way it is guaranteed that the grains that are not thrown out by the thresher teeth of the rotor are strongly dragged by the suction generated by the air current oriented towards the outlet, conducted by the head hood.

The additional air current that is incorporated with the present invention guarantees that all grains are conducted upwards and downwards the head.

Said conducted air current has as main function the creation of a depression zone (“vacuum”) in the interior section of the head, generating the above mentioned suction in the grains that due to different reasons (collisions one into the other, blows against the hood, etc.) tend to fall into the soil.

For said reasons, the fan that constitutes the invented head, located at the interior of the rotor, coaxially thereto, takes air from the ends (as any other axial fan does) and said air is distributed all around the periphery, to constitute a strong air current that, conducted by the channel deflector, takes the grains when they go out from the thresher zone. This current is conducted upwards and guided then by the top head hood, towards the rear section where the worm carrier is located.

Inventive Activity

No thresher head attached to a harvester that are known today, proposes or at least suggests the constructive solution specified in the preceding paragraphs, that's why, this is a proposal not only new but with a clear inventive activity.

### BRIEF DESCRIPTION OF THE FIGURES

To carry out the superficially mentioned advantages, to which the users and the skilled people in the art may add many others more, and to facilitate the understanding of the constructive, constitutive and functional features of the invented thresher head, a preferred example of embodiment is described below, which is schematically illustrated and without a determined scale in the enclosed sheets, clearly expressing that as an example it is not limited or exclusive to the protection scope of the present patent, but it is merely an explanation and illustration of the inventive basis.

FIG. 1 is a scheme in vertical section where the parts and basic elements that constitute the thresher head of this invention are represented.

FIG. 2 is a detail in lateral section that represents, in this case a rotor holding eight rows of thresher blades, as well as the axial fan that generates the air current, and the deflector that guides the flow outlet.

FIG. 3 is a extended detail that represents a preferred embodiment of the thresher teeth that are distributed in rows over the rotor.

For the purpose of clarifying, in every figure, like numbers and reference letters, correspond to the same or equivalent parts or constitutive elements of the assembly, according to the example selected for the present explanation of the invented thresher head.

### DETAILED DESCRIPTION OF A PREFERRED EXAMPLE

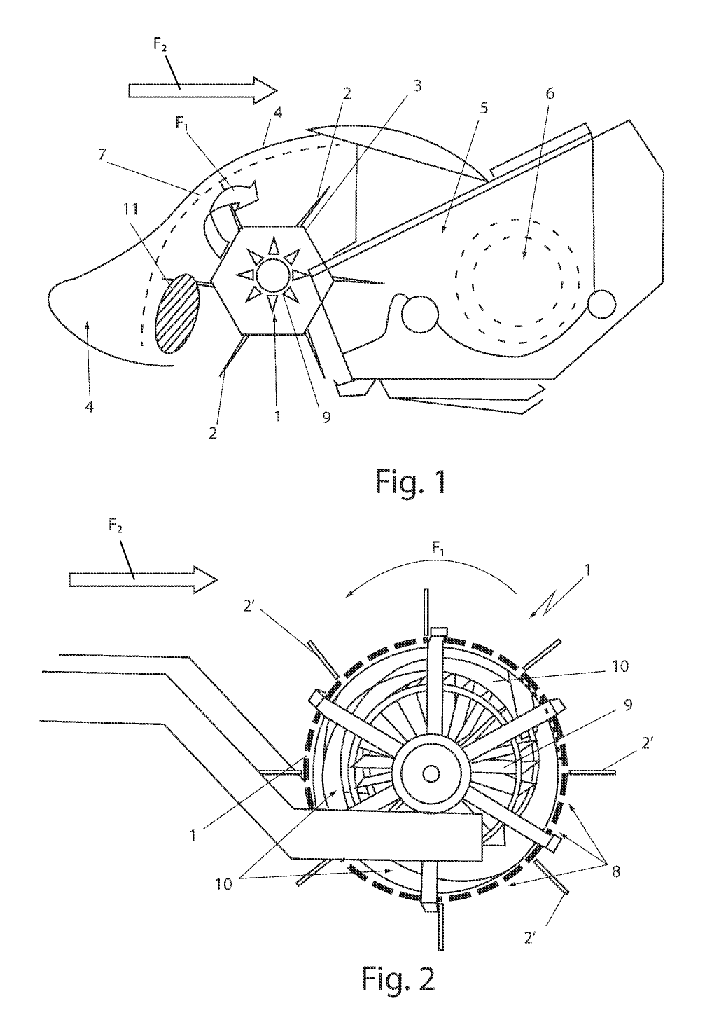

As it can be appreciated in FIG. 1, the thresher head referred to in the present invention pertains to the type of those that comprises a unit over a light cantilevered rack projecting from the front face of a harvester.

This head pertains to those having a cross rotor (1) that comprises all the ploughing width, which in this preferred example, is defined in a cylindrical hollow body, that may be of a polygonal section, holding six rows of threshers teeth (2), (as shown in FIG. 1), or of eight rows of thresher teeth (2′), (as shown in FIG. 2), that are radially projected outwards from the surroundings of its longitudinal awners (3), with a relative inclination of about 30°.

The invention takes into account that the same rotor (1) may be cylindrical, of circumferential section, holding eight rows of thresher teeth (2′), in this case represented in FIG. 2.

To clearly keep the graphic interpretation of the operation of the invented head, in these FIGS. 1 and 2 the parts that take part in the rotating movement are not included, said movement may be produced by belts and pulleys that extend from the harvester (not shown), or combinations thereof with epicycloidal transmission gears. In this sense, it is hereby clarified that the rotor is rotatory assembled in the direction and sense (F1) opposite to the sense of progress of the machine (F2).

Same FIG. 1 shows that above said thresher rotor (1) the head includes a hood (4) of a height and regulatory inclination with respect to the soil, so that the amount of material that will be put into contact with the thresher teeth of the rotor is determined depending on the proximity or distance thereof.

Said hood (4) is projected upwards above the rotor, acting as a limiting face that directs the route of the grains towards the rear section (5) of the same head, as represented by the dashed curve line (7).

Grains that come into this rear section (5) may be carried to the harvester through a worm (6).

Furthermore, as represented in FIG. 2, said hollow rotor (1) has a cylindrical wall affected by a multiplicity of through openings (8). It may be said that it refers to a hollow rotor having a sieving wall.

As it was said in the previous paragraphs, and represented in FIGS. 1 and 2, the head of this invention is distinguished by the incorporation of a new axial fan (9) arranged in the interior of the rotor, coaxially oriented, which, as it was previously mentioned, rotates at a higher speed than the rotor, generating an axial air current addressed outwards, passing through the referred screens (8). In this way, an air flow is established which helps to carry the grains following said path (7).

In effect, this fan (9) takes air from the head sides and said air is axially addressed generating a current that passes through, in an homogeneous manner, the rotor wall (1), being specially featured that, between the fan and said rotor wall, a special air deflector (10) is arranged, a flow channel (shown in FIG. 2) which function consists of addressing the flow towards a lower outlet in an ascending sense, causing a depression zone (11) (represented in FIG. 1) where a great suction having sense and direction is generated (F1).

This flow channel is a smooth face such as a bent plate, constituting a substantially cylindrical body coaxial to the rotor that extends from end to end covering more than a half of the cylindrical curvature of the rotor, leaving said lower communication free, specially destined to the discharge of the air flow that passes through the wall thereof.

If FIG. 2 is specially observed, it will be appreciated that the mentioned air deflector (10) is called flow channel due to the fact that it addresses the air current towards the referred lower outlet, so not only does it benefit the ascending route of the grains driven by the rotor during its rotation, but it also drags those grains that are going to fall into the soil, therefore increasing the integral efficiency of the head.

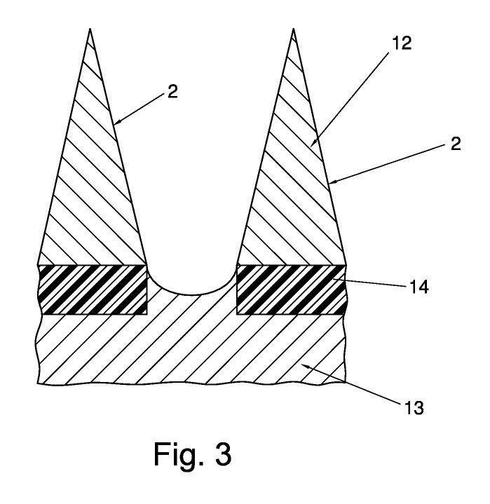

As it was previously said, the head of this invention may have a rotor holding six or more thresher teeth (2), which, as represented in FIG. 3, in preferred embodiments they may present a top active part (12) made of metal and in V-shape, bound to the wall (13) of the rotor, by means of a part (14) of flexible preferably elastomeric material. In this way, maintenance costs are substantially reduced due to, as a consequence of the metallic part, the teeth durability increases without loss of flexibility.

Furthermore, it is hereby considered that the edges of the referred teeth (2) of the rotor define an awner addressed in such a way that it helps to throw out the grains in the referred direction and sense towards the interior of the head.

1. THRESHER HEAD WITH BUILT-IN PNEUMATIC SUCTION TO BE USED BY A HARVESTER, of the type of those usually called “Stripper” head, cantilevered projecting from the front face of a harvester, incorporating a front and cross rotor, that comprises all the ploughing width, rotating in the opposite direction to the progress of the machine, and holding thresher teeth alignments, through which fruits (grains) are being pulled, which, in turn, by centrifugal force, are thrown out towards the harvester, characterized in that said rotor is a hollow cylindrical body of a polygonal section, assembled in a horizontal axis and associated to command means that produce an independent rotatory movement; its cylindrical wall is affected by a multiplicity of minor openings, through which the air current generated by an axial concentric fan may move along, said fan that is arranged within said wall, takes air from the ends to generate a flow addressed towards the rotor wall, and is associated to command means that produce an independent rotatory movement of the same sense as the rotor; furthermore, a flow channel placed between the cylindrical wall of the rotor and the referred axial fan is arranged, comprising a face such as a flat bent plate, having the format of a substantially cylindrical body, coaxial to the rotor, extending from end to end, in the horizontal plane, covering more than half of the cylindrical curvature of said rotor, leaving a lower communication free that addresses the air flow in an ascending direction towards the discharge outlet of the grains.

2. THRESHER HEAD WITH BUILT-IN PNEUMATIC SUCTION, according to claim 1, characterized in that, the hollow rotor, holding the thresher teeth, rotates, at a lesser speed than and at the same sense and direction as the axial fan.

3. THRESHER HEAD WITH BUILT-IN PNEUMATIC SUCTION, according to claim 1, characterized in that, the command that produces the independent rotatory movement of the rotor comprises transmission belts and pulleys extending from the harvester.

4. THRESHER HEAD WITH BUILT-IN PNEUMATIC SUCTION, according to claim 1, characterized in that the command that produces the independent rotatory movement of the rotor comprises transmission belts and pulleys extending from the harvester, combined with epicycloidal transmission gears.

5. THRESHER HEAD WITH BUILT-IN PNEUMATIC SUCTION, according to claim 1, characterized in that the wall of the cylindrical rotor of polygonal section, is a sieved wall.

6. THRESHER HEAD WITH BUILT-IN PNEUMATIC SUCTION, according to claim 1, characterized in that the flow channel is a curved air deflector that addresses the flow towards the lower outlet in an ascending sense, generating a depression where a great suction having ascending sense and direction is produced.

7. THRESHER HEAD WITH BUILT-IN PNEUMATIC SUCTION, according to claim 1, characterized in that the flow channel is a smooth face such as a bent plate, constituting a substantially cylindrical body coaxial to the rotor, that extends from end to end covering more than a half of the cylindrical curvature of the rotor, leaving said lower communication free, specially destined to the discharge of the air flow that passes through the wall thereof.
